(19) United States
(12) Patent Application Publication
(10) Pub. No.: US 2026/0197133 A1
(43) Pub. Date: Jul. 9, 2026

(54) INFORMATION PROCESSING DEVICE, INFORMATION PROCESSING METHOD, AND RECORDING MEDIUM

(71) Applicant: Panasonic Intellectual Property Management Co., Ltd., Osaka (JP)

(72) Inventors: Satoshi SAWANO, Osaka (JP); Masato MATSUMOTO, Osaka (JP)

(21) Appl. No.: 19/134,615

(22) PCT Filed: Aug. 4, 2023
(86) PCT No.: PCT/JP2023/028572

§ 371 Date: May 30, 2025

(30) Foreign Application Priority Data
Dec. 16, 2022 (JP) 2022-200778

(51) Int. Cl. H04L 5/00

(52) U.S. Cl. CPC H04L 5/0048

(57) ABSTRACT

An information processing device includes: a generator that generates a reference signal and transmits the reference signal to a first device and a second device; and a processing unit that: (a) receives a first information transmitted from the first device that has received the reference signal, and also receives, as a first reference signal, the reference signal transmitted from the first device together with the first information; (b) receives a second information transmitted from the second device that has received the reference signal, and also receives, as a second reference signal, the reference signal transmitted from the second device together with the second information; and (c) integrates the first information and the second information into information in which the first information and the second information have a common time axis, using a time difference between the first reference signal and the second reference signal.

### TECHNICAL FIELD

The present invention relates to an information processing device, an information processing method, and a program.

### BACKGROUND ART

A diagnostic device, a diagnostic system, and a program are disclosed (see Patent Literature (PTL) 1), wherein, in machining processing such as cutting, grinding, or polishing of a workpiece using a machining device or the like, data output from a sensor provided independently of the machining device is associated with a monitoring designation number for the machining processing to enable the data to be analyzed for each monitoring designation number.

### CITATION LIST

### Patent Literature

### [PTL 1]

Japanese Unexamined Patent Application Publication No. 2020-166543

### SUMMARY OF INVENTION

### Technical Problem

However, the technique disclosed in PTL 1 has a problem in that it is not possible to evaluate a vibration generated by the machining device and time-series data of an internal control signal or a command value of the machining device on a common time axis.

To address this, the present invention provides an information processing device and the like that can assist in evaluation of a plurality of time-series data on a common time axis.

### Solution to Problem

An information processing device according to one aspect of the present invention is an information processing device that integrates first information and second information, the first information including a time-series first value that is a time-series sensor value output from a sensor device provided in a machining device or a time-series control value related to control of the machining device, the second information including a time-series second value that is a time-series sensor value output from the sensor device provided in the machining device or a time-series control value related to the control of the machining device, the information processing device including: a generator that generates a reference signal and transmits the reference signal generated to a first device that is a transmission source of the first information and a second device that is a transmission source of the second information; and a processing unit that: (a) receives the first information transmitted from the first device that has received the reference signal, and also receives, as a first reference signal, the reference signal transmitted from the first device together with the first information; (b) receives the second information transmitted from the second device that has received the reference signal, and also receives, as a second reference signal, the reference signal transmitted from the second device together with the second information; and (c) integrates the first information and the second information into information in which the first information and the second information have a common time axis, using a time difference between the first reference signal and the second reference signal.

General and specific aspects disclosed above may be implemented using a system, a method, an integrated circuit, a computer program, or a computer-readable recording medium such as a CD-ROM, or any combination thereof.

### Advantageous Effects of Invention

The information processing device according to the present invention can assist in evaluation of a plurality of time-series data on a common time axis.

### BRIEF DESCRIPTION OF DRAWINGS

FIG. 1 is a schematic diagram showing a configuration of an information processing device and a system according to an embodiment.

FIG. 2 is a first flowchart illustrating processing performed by the information processing device according to the embodiment.

FIG. 3 is a second flowchart illustrating the processing performed by the information processing device according to the embodiment.

FIG. 4 is a third flowchart illustrating the processing performed by the information processing device according to the embodiment.

FIG. 5 is a first diagram showing integration processing performed by the information processing device according to the embodiment.

FIG. 6 is a second diagram showing the integration processing performed by the information processing device according to the embodiment.

FIG. 7 is a third diagram showing the integration processing performed by the information processing device according to the embodiment.

FIG. 8 is a fourth diagram showing the integration processing performed by the information processing device according to the embodiment.

FIG. 9 is a fifth diagram showing the integration processing performed by the information processing device according to the embodiment.

FIG. 10 is a sixth diagram showing the integration processing performed by the information processing device according to the embodiment.

FIG. 11 is a diagram showing an example of how integrated information is displayed by the information processing device according to the embodiment.

### DESCRIPTION OF EMBODIMENTS

### (Underlying Knowledge Forming Basis of the Present Disclosure)

The inventor of the present application found that the following problem arises in the technique related to the machining device disclosed in the Background Art section.

According to the technique disclosed in PTL 1, vibration data can be associated with a sequence number for identifying the machining processing only after the vibration data has been acquired based on a machining feed signal.

For this reason, the technique disclosed in PTL 1 has a problem in that it is not possible to evaluate the vibration and the internal control signal or the command value of the machining device that were generated at the same time point on a common time axis because information that indicates the vibration generated by the machining device and the time-series data of the internal control signal or the command values of the machining device cannot be synchronized on the time axis.

In view of the above, the present invention provides an information processing device and the like that allows a plurality of time-series data to be evaluated on a common time axis.

Hereinafter, an invention derived from the disclosure in the specification of the present application will be illustrated, and advantageous effects and the like obtained from the invention will be described.
(1) An information processing device that integrates first information and second information, the first information including a time-series first value that is a time-series sensor value output from a sensor device provided in a machining device or a time-series control value related to control of the machining device, the second information including a time-series second value that is a time-series sensor value output from the sensor device provided in the machining device or a time-series control value related to the control of the machining device, the information processing device including: a generator that generates a reference signal and transmits the reference signal generated to a first device that is a transmission source of the first information and a second device that is a transmission source of the second information; and a processing unit that: (a) receives the first information transmitted from the first device that has received the reference signal, and also receives, as a first reference signal, the reference signal transmitted from the first device together with the first information; (b) receives the second information transmitted from the second device that has received the reference signal, and also receives, as a second reference signal, the reference signal transmitted from the second device together with the second information; and (c) integrates the first information and the second information into information in which the first information and the second information have a common time axis, using a time difference between the first reference signal and the second reference signal.

According to the aspect described above, the information processing device integrates the first information and the second information into information in which the first information and the second information have a common time axis. The information processing device transmits, in advance, the reference signal to the first device and the second device, and uses the time difference between the first reference signal and the second reference signal respectively transmitted from the first device and the second device to integrate the first information and the second information. Accordingly, the first information and the second information can be integrated appropriately into the information in which the first information and the second information have a common time axis. As described above, the information processing device can assist in evaluation of a plurality of time-series data on a common time axis.
(2) The information processing device according to clause (1), wherein the generator repeatedly broadcasts the reference signal to the first device and the second device, and the processing unit receives, based on the reference signal repeatedly transmitted from the generator, the first reference signal and the second reference signal repeatedly transmitted from the first device and the second device, and integrates the first information and the second information using the first reference signal and the second reference signal.

According to the aspect described above, the information processing device can cause both the first device and the second device to receive the same reference signal by broadcasting the reference signal. Also, the information processing device can integrate the first information and the second information to cause the first reference signal and the second reference signal respectively transmitted from the first device and the second device to be signals at an identical time point, and thus can more easily integrate the first information and the second information. Accordingly, the information processing device can more easily assist in evaluation of a plurality of time-series data on a common time axis.
(3) The information processing device according to clause (2), wherein the time-series first value and the time-series second value have an identical sampling rate, and the processing unit integrates the first information and the second information by arranging the time-series first value and the time-series second value to cause the first reference signal and the second reference signal that are based on the reference signal common to the first reference signal and the second reference signal to be signals at an identical time point.

According to the aspect described above, the information processing device can more easily integrate the first information and the second information by arranging the first information and the second information to cause the first reference signal and the second reference signal to be signals at an identical time point. At this time, the time-series first value and the time-series second value have an identical sampling rate, and thus the information processing device can more easily integrate the first information and the second information appropriately without making an adjustment such as providing a time interval between the time-series values. Accordingly, the information processing device can more easily assist in evaluation of a plurality of time-series data on a common time axis.
(4) The information processing device according to clause (2), wherein the time-series first value and the time-series second value have different sampling rates, and the processing unit integrates the first information and the second information by arranging one of the time-series first value or the time-series second value that has a shorter sampling rate and then arranging another one of the time-series first value or the time-series second value to cause: (i) the first reference signal and the second reference signal that are based on the reference signal common to the first reference signal and the second reference signal to be signals at an identical time point; and (ii) the time-series first value and the time-series second value to be spaced apart according to a ratio of the sampling rate of the time-series first value to the sampling rate of the time-series second value.

According to the aspect described above, the information processing device can more easily integrate the first information and the second information by arranging the first information and the second information to cause the first reference signal and the second reference signal to be signals at an identical time point. At this time, the time-series first value and the time-series second value have different sampling rates, and thus by providing an appropriate time interval to one of the two time-series values that has a longer sampling rate, the first information and the second information can be integrated appropriately. Accordingly, the information processing device can more appropriately assist in evaluation of a plurality of time-series data on a common time axis even when the time-series values have different sampling rates.
(5) The information processing device according to clause (1), wherein the generator repeatedly selects one of the first device or the second device and unicasts the reference signal to the one of the first device or the second device selected, and the processing unit receives, based on the reference signal repeatedly transmitted from the generator, the first reference signal and the second reference signal repeatedly transmitted from the first device and the second device, and integrates the first information and the second information using the first reference signal and the second reference signal.

According to the aspect described above, the information processing device can cause the first device and the second device to receive the reference signal by unicasting the reference signal to one of the first device or the second device repeatedly selected. Also, the information processing device can integrate the first information and the second information by adjusting the time of the first information and the time of the second information using the first reference signal and the second reference signal respectively transmitted from the first device and the second device. Accordingly, the information processing device can more easily assist in evaluation of a plurality of time-series data on a common time axis.
(6) The information processing device according to clause (5), wherein the time-series first value and the time-series second value have an identical sampling rate, and the processing unit: interpolates a first reference signal not received using a plurality of first reference signals received, each of which is the first reference signal; interpolates a second reference signal not received using a plurality of second reference signals received, the second reference signal not received and the plurality of second reference signals received being the second reference signal as defined in clause (1); and integrates the first information and the second information by arranging the time-series first value and the time-series second value to cause the first reference signal and the second reference signal that are based on the reference signal common to the first reference signal and the second reference signal to be signals at an identical time point.

According to the aspect described above, the information processing device can more easily integrate the first information and the second information by interpolating a first reference signal not received and a second reference signal not received using the first reference signals and the second reference signals respectively received from the first device and the second device, and then arranging the first information and the second information to cause the first reference signal and the second reference signal to be signals at an identical time point. At this time, the time-series first value and the time-series second value have an identical sampling rate, and thus the information processing device can more easily integrate the first information and the second information appropriately without making an adjustment such as providing a time interval between the time-series values. Accordingly, the information processing device can more easily assist in evaluation of a plurality of time-series data on a common time axis.
(7) The information processing device according to clause (5),
wherein the time-series first value and the time-series second value have an identical sampling rate, and the processing unit: interpolates a first reference signal not received using a plurality of first reference signals received, each of which is the first reference signal; interpolates a second reference signal not received using a plurality of second reference signals received, the second reference signal not received and the plurality of second reference signals received being the second reference signal as defined in clause (1); and integrates the first information and the second information by (1) arranging one of the time-series first value or the time-series second value that has a shorter sampling rate, and then (2) arranging another one of the time-series first value or the time-series second value to cause: (i) the first reference signal and the second reference signal that are based on the reference signal common to the first reference signal and the second reference signal to be signals at an identical time point; and (ii) the time-series first value and the time-series second value to be spaced apart according to a ratio of the sampling rate of the time-series first value to the sampling rate of the time-series second value.

According to the aspect described above, the information processing device can more easily integrate the first information and the second information by arranging the first information and the second information to cause the first reference signal and the second reference signal interpolated to be signals at an identical time point. At this time, the time-series first value and the time-series second value have different sampling rates, and thus by providing an appropriate time interval to one of the two time-series values that has a longer sampling rate, the first information and the second information can be integrated as appropriate. Accordingly, the information processing device can more appropriately assist in evaluation of a plurality of time-series data on a common time axis even when the time-series values have different sampling rates.
(8) The information processing device according to any one of clauses (1) to (7), wherein the time-series first value or the time-series second value is a time-series sensor value or a time-series control value, and the processing unit includes an analyzer that analyzes the time-series sensor value or the time-series control value.

According to the aspect described above, the information processing device can obtain a time-series analysis value by analyzing the time-series sensor value or the time-series control value, and use the time-series analysis value as an evaluation target on a common time axis. Accordingly, the information processing device can assist in evaluation of a plurality of time-series data on a common time axis.
(9) The information processing device according to clause (8), wherein the analyzer performs a different type of analysis processing according to a type of the time-series sensor value to be analyzed or a type of the time-series control value to be analyzed.

According to the aspect described above, the information processing device can obtain an appropriate analysis value by performing analysis processing appropriate for each of the type of the time-series sensor value or the type of the time-series control value. Accordingly, the information processing device can more appropriately assist in evaluation of a plurality of time-series data on a common time axis.
(10) The information processing device according to clause (8) or (9), wherein the processing unit includes a determiner that determines a state of machining performed by the machining device using a result of the analysis performed by the analyzer.

According to the aspect described above, the information processing device can obtain the state of machining performed by the machining device determined using the analysis value obtained from the sensor value, and use the obtained result as an evaluation target on a common time axis. Accordingly, the information processing device can more appropriately assist in evaluation of a plurality of time-series data on a common time axis.
(11) The information processing device according to any one of clauses (1) to (10), wherein the processing unit generates integrated information by integrating the first information and the second information, and the information processing device further includes a display that displays the integrated information.

According to the aspect described above, the information processing device can, by displaying the integrated information, cause the evaluation of a plurality of time-series data on a common time axis to be performed more easily. Accordingly, the information processing device can assist in evaluation of a plurality of time-series data on a common time axis.
(12) The information processing device according to clause (11), wherein the generator generates a new reference signal and transmits the new reference signal generated, the processing unit generates new integrated information by receiving new first information, new first reference signal, new second information, and new second reference signal, and integrating the new first information and the new second information, and the display updates the integrated information displayed with the new integrated information.

According to the aspect described above, the information processing device can update the displayed integrated information over time, and cause the evaluation of a plurality of time-series data on a common time axis to be performed more easily. Accordingly, the information processing device can assist in evaluation of a plurality of time-series data on a common time axis.
(13) The information processing device according to clause (11) or (12), wherein the display receives a selection of one or more information items included in the integrated information by a user, and displays at least one of the one or more information items according to the selection received.

According to the aspect described above, the information processing device displays at least one information item selected by the user. Accordingly, the user can cause the information processing device to display information the user wants to view, and use as an evaluation target on a common time axis in a plurality of time-series data. Accordingly, the information processing device can assist in evaluation of a plurality of time-series data on a common time axis.
(14) The information processing device according to any one of clauses (1) to (13), wherein the sensor device includes at least one of an acceleration sensor, a voltage sensor, an electric current sensor, or a temperature sensor.

According to the aspect described above, the information processing device assist in evaluation of time-series data of at least one of the acceleration sensor, the voltage sensor, the electric current sensor, or the temperature sensor on a common time axis.
(15) An information processing method to be executed by an information processing device that integrates first information and second information, the first information including a time-series first value that is a time-series sensor value output from a sensor device provided in a machining device or a time-series control value related to control of the machining device, the second information including a time-series second value that is a time-series sensor value output from the sensor device provided in the machining device or a time-series control value related to the control of the machining device, the information processing method including: generating a reference signal and transmitting the reference signal generated to a first device that is a transmission source of the first information and a second device that is a transmission source of the second information; (a) receiving the first information transmitted from the first device that has received the reference signal, and also receiving, as a first reference signal, the reference signal transmitted from the first device together with the first information; (b) receiving the second information transmitted from the second device that has received the reference signal, and also receiving, as a second reference signal, the reference signal transmitted from the second device together with the second information; and (c) integrating the first information and the second information into information in which the first information and the second information have a common time axis, using a time difference between the first reference signal and the second reference signal.

According to the aspect described above, the same advantageous effects as those of the information processing device described above can be obtained.
(16) The information processing method according to clause (15), wherein the integrating includes generating integrated information of the first information and the second information, and the information processing method further includes displaying the integrated information on a display.

According to the aspect described above, the same advantageous effects as those of the information processing device described above can be obtained.
(17) A program that causes a computer to execute the information processing method according to clause (15) or (16).

According to the aspect described above, the same advantageous effects as those of the information processing device described above can be obtained.

General and specific aspects disclosed above may be implemented using a system, a method, an integrated circuit, a computer program, or a computer-readable recording medium such as a CD-ROM, or any combination thereof.

Hereinafter, an embodiment will be described specifically with reference to the accompanying drawings.

The embodiment described below shows a generic or specific example of the present invention. The numerical values, shapes, materials, structural elements, the arrangement and connection of the structural elements, steps, the order of the steps, and the like shown in the following embodiments are merely examples, and therefore are not intended to limit the scope of the present invention. Also, among the structural elements described in the following embodiment, structural elements not recited in any one of the independent claims are described as arbitrary structural elements.

### Embodiment

In the present embodiment, an information processing device and the like that can assist in evaluation of a plurality of time-series data on a common time axis will be described.

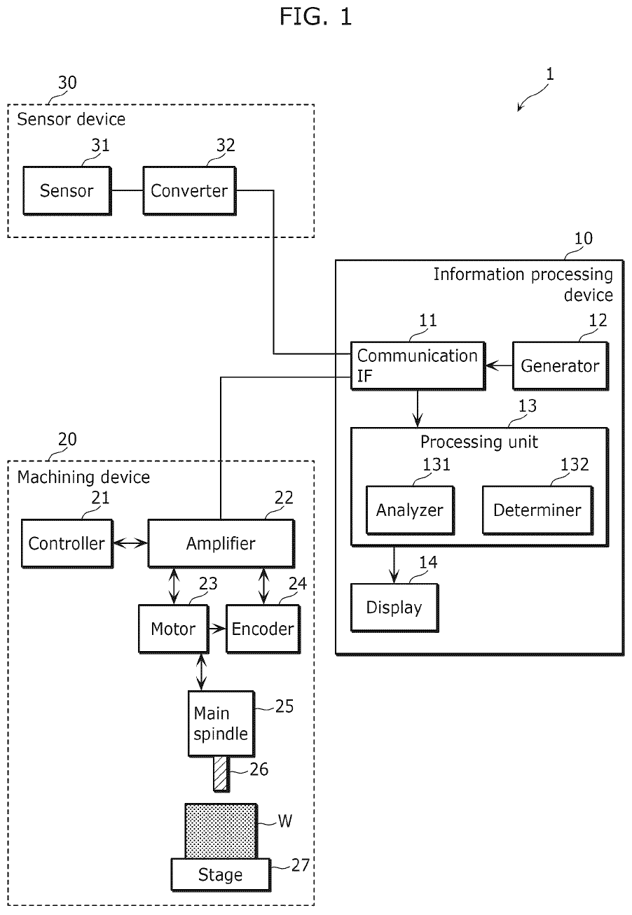

FIG. 1 is a schematic diagram showing a configuration of information processing device 10 according to the present embodiment and system 1 that includes information processing device 10.

System 1 includes information processing device 10, machining device 20, and sensor device 30. Information processing device 10 is connected to machining device 20 and sensor device 30. Information processing device 10 may be a device (also generally called “diagnostic device” or “analysis device) that diagnoses machining device 20 or machining performed by machining device 20 by analyzing a vibration generated by machining device 20 during the machining. Also, information processing device 10 may be provided in one of machining device 20 or sensor device 30 as a function of the device.

First, machining device 20 and sensor device 30 will be described.

Machining device 20 is a device that performs machining on workpiece W. The machining includes cutting, grinding, polishing, and the like. Machining device 20 can output a control value related to control of machining device 20.

As shown in FIG. 1, machining device 20 includes controller 21, amplifier 22, motor 23, encoder 24, main spindle 25, and tool 26. Note that workpiece W is not regarded as a structural element included in machining device 20.

Controller 21 performs control on the structural elements included in machining device 20. Controller 21 includes a processor (for example, a central processing unit (CPU)) (not shown), and performs the control by the processor executing a predetermined program using a memory (not shown).

Controller 21 controls the structural elements of machining device 20 such that workpiece W is machined. Here, an example will be described in which, for example, main spindle 25 is a control target. Stage 27 and the like are also regarded as structural elements included in machining device 20.

Controller 21 controls the position of main spindle 25 to cause main spindle 25 to be located at an appropriate position. Also, controller 21 controls the rotation speed of main spindle 25 and tool 26 to cause tool 26 to machine workpiece W. Controller 21 provides, to amplifier 22, a signal for controlling the position (also referred to as “controlled position”) of main spindle 25 after control, the rotation speed (controlled rotation speed) of main spindle 25 after control, or the torque (also referred to as “controlled torque”) of main spindle 25 after control.

Amplifier 22 drives motor 23 by supplying electric power to motor 23. Amplifier 22 may include a servo amplifier that drives motor 23 that is a servo motor and controls the position of main spindle 25 or a spindle amplifier that drives motor 23 that is a spindle motor and controls the rotation of main spindle 25.

When amplifier 22 acquires the signal for controlling the controlled position, the controlled rotation speed, or the controlled torque of main spindle 25 from controller 21, amplifier 22 calculates a driving amount of motor 23 required to change the position, the rotation speed, or the torque of main spindle 25 according to the control signal, and supplies, to motor 23, electric power required to drive motor 23 based on the calculated driving amount. Also, amplifier 22 can receive information that indicates the position or the rotation speed of motor 23 from encoder 24 as a feedback, and thus further adjust the position or the rotation speed of main spindle 25 using the feedback. It can be said that the information that indicates the position or the rotation speed of motor 23 is information that indicates the position or the rotation speed of main spindle 25 because motor 23 and main spindle 25 are directly connected to each other. As amplifier 22, a number of amplifiers required to drive one or more motors 23 are provided in machining device 20.

Also, amplifier 22 transmits time-series data of control value related to control of machining device 20 to information processing device 10 via communication IF (not shown). The control value related to control of machining device 20 includes information that indicates the controlled position, the controlled rotation speed, or the controlled torque of main spindle 25 or information that indicates the position, the rotation speed, or the torque of main spindle 25 acquired from encoder 24, and the like. The transmission of the control value to information processing device 10 by amplifier 22 corresponds to outputting of the control value.

Motor 23 controls the position or the rotation speed of main spindle 25. Motor 23 may include a servo motor that controls the position of main spindle 25 or a spindle motor that controls the rotation of main spindle 25. Motor 23 controls the position or the rotation speed of main spindle 25 by being driven by the electric power supplied from amplifier 22.

The number of motors 23 is not limited to one, and may be more than one. For example, in the case of controlling the position and the rotation speed of main spindle 25, one or more motors for controlling the position of main spindle 25 and one or more motors for controlling the rotation speed of main spindle 25 may be provided. In the case where the number of motors 23 is one or more, a number of amplifiers 22 required to drive one or more motors 23 are provided. Also, in the case where stage 27 is a control target to be controlled by controller 21, one or more motors for controlling the position of stage 27 are provided.

Encoder 24 is a sensor that acquires information that indicates the position or the rotation speed of main spindle 25. Encoder 24 provides information that indicates the position or the rotation speed of main spindle 25 acquired to amplifier 22 as a feedback. Encoder 24 may be a linear encoder or a rotary encoder.

Main spindle 25 rotatably supports tool 26. Specifically, main spindle 25 includes a jig, such as a chuck, for holding tool 26, and holds tool 26 using the jig. Also, main spindle 25 causes tool 26 to rotate (or in other words, revolves) about the pivot axis.

Tool 26 is a tool for machining workpiece W. Tool 26 is supported by main spindle 25 so as to be capable of rotate (or in other words, revolves) about the pivot axis. As a result of rotating tool 26 coming into contact with workpiece W, workpiece W is machined.

Stage 27 is a stage on which workpiece W is placed. Stage 27 may be fixed or movable. In the case where stage 27 is movable, a motor (not shown) for moving stage 27 is provided, and a servo amplifier (not shown) for supplying electric power to the motor is also provided.

Sensor device 30 is a device that senses a physical phenomenon and outputs a sensor value, and is provided in machining device 20.

Sensor device 30 includes sensor 31 and converter 32.

Sensor 31 is a sensor (also generally called “sensor element”) that senses a physical phenomenon that is a sensing target. Sensor 31 includes, for example, an acceleration sensor, a voltage sensor, an electric current sensor, a temperature sensor, or the like. Sensor 31 provides, to converter 32, a sensor value (also called “analog sensor value”) that indicates the sensed physical phenomenon in an analog manner.

Converter 32 converts the analog sensor value provided from sensor 31 to a digital sensor value (also referred to simply as “sensor value”) and transmits the digital sensor value to information processing device 10. Converter 32 acquires the analog sensor value provided from sensor 31 and repeatedly converts the acquired analog sensor value to a sensor value and transmits the sensor value to information processing device 10. Converter 32 can repeatedly convert an analog sensor value to a sensor value during a predetermined period (also referred to as “sampling rate”). The conversion of an analog sensor value to a sensor value may include analog digital conversion processing, filter processing, buffer processing, and the like. The transmission of the sensor value to information processing device 10 by converter 32 corresponds to outputting of the sensor value.

Next, information processing device 10 will be described.

As shown in FIG. 1, information processing device 10 includes communication IF 11, generator 12, processing unit 13, and display 14. A portion or all of the functions of generator 12, processing unit 13, and display 14 can be implemented by a processor (for example, a central processing unit (CPU)) (not shown) included in information processing device 10 executing a predetermined program using a memory (not shown).

Information processing device 10 is an information processing device that integrates first information and second information.

The first information includes a time-series first value that is a time-series sensor value output from sensor device 30 or a time-series control value related to control of machining device 20. Also, the second information includes a time-series second value that is a time-series sensor value output from sensor device 30 provided in machining device 20 or a time-series control value related to control of machining device 20. The transmission source of the first information may also be referred to as “first device, and the transmission source of the second information may also be referred to as “second device”. The first device and the second device are devices that are different from each other.

In the present embodiment, an example will be described in which the first information includes the time-series sensor value output from sensor device 30 as the time-series first value, and the second information includes the time-series control value related to control of machining device 20 as the time-series second value. In this case, sensor device 30 corresponds to the first device, and machining device 20 corresponds to the second device.

The first information, the second information, the first device, and the second device are not limited to those described above. The first information may include the time-series sensor value, and the second information may include the time-series sensor value. Also, the first information may include the time-series control value, and the second information may include the time-series control value.

Communication IF 11 is a communication interface connected to machining device 20 (more specifically, amplifier 22) and sensor device 30 so as to be capable of performing communication. The communication standard of communication IF 11 is, for example, a wired local area network (LAN) such as IEEE 802.3, but may be a wireless LAN (IEEE 802.11 series or the like).

Generator 12 generates a reference signal, and transmits the generated reference signal to sensor device 30 and machining device 20 via communication IF 11. Generator 12 repeatedly generates and transmits reference signals. Each of the reference signals repeatedly generated by generator 12 contains an identifier for uniquely identifying the reference signal. For example, generator 12 places a value incremented by one (also referred to as “counter value”) in each of the reference signals that generator 12 repeatedly generates.

Generator 12 may broadcast or unicast the reference signal. In the case where generator 12 unicasts the reference signal, generator 12 repeatedly selects one of sensor device 30 or machining device 20, and unicasts the reference signal to the selected device. For example, generator 12 alternately selects sensor device 30 or machining device 20 as the selected device. In this case, generator 12 alternately unicasts the reference signal to sensor device 30 or machining device 20. Generator 12 may select sensor device 30 or machining device 20 at an arbitrary ratio, or may randomly select sensor device 30 or machining device 20. However, the following case is excluded: generator 12 continuously selects sensor device 30 or machining device 20 a plurality of times (for example, about several tens to one hundred times or more).

Processing unit 13 receives the first information transmitted from sensor device 30 and the second information transmitted from machining device 20 via communication IF 11, and integrates the first information and the second information.

Specifically, processing unit 13 receives the first information transmitted from sensor device 30 that has received the reference signal transmitted from generator 12 via communication IF 11. Also, processing unit 13 receives, as a first reference signal, the reference signal transmitted from sensor device 30 together with the first information. The first reference signal is the reference signal transmitted from sensor device 30 that has received the reference signal transmitted from generator 12, and is the same signal as the reference signal transmitted from generator 12. In the case where generator 12 repeatedly transmits the reference signal, processing unit 13 receives the first reference signal transmitted from sensor device 30 in response to each of the repeatedly transmitted reference signals.

Also, processing unit 13 receives the second information transmitted from machining device 20 that has received the reference signal transmitted from generator 12 via communication IF 11. Also, processing unit 13 receives, as a second reference signal, the reference signal transmitted from machining device 20 together with the second information. The second reference signal is the reference signal transmitted from machining device 20 that has received the reference signal transmitted from generator 12 and is the same signal as the reference signal transmitted from generator 12. In the case where generator 12 repeatedly transmits the reference signal, processing unit 13 receives the second reference signal transmitted from machining device 20 in response to each of the repeatedly transmitted reference signals.

Then, processing unit 13 integrates the first information and the second information into information in which the first information and the second information have a common time axis, using a time difference between the first reference signal and the second reference signal. Specifically, processing unit 13 integrates the first information and the second information to cause the first reference signal and the second reference signal to be signals at an identical time point, using a time difference between the first reference signal and the second reference signal. Processing unit 13 generates integrated information when integrating the first information and the second information. When generator 12 transmits a new reference signal, processing unit 13 receives new first information, new first reference signal, new second information, and new second reference signal, and generates new integrated information by integrating the new first information and the new second information. The processing of integrating the first information and the second information performed by processing unit 13 will be described later in detail.

Also, processing unit 13 includes analyzer 131 and determiner 132.

Analyzer 131 analyzes the time-series sensor value or the time-series control value. Specifically, analyzer 131 performs analysis on the time-series sensor value output from sensor device 30 or the time-series control value output from machining device 20, and thereby obtains a time-series analysis value. The analysis includes, for example, short-time frequency analysis (short time fourier transform (STFT)) processing, time frequency analysis (wavelet analysis) processing, and the like. Also, the analysis may also include, for example, processing of calculating, a moving average value, an effective value, a maximum value or a minimum value of the signal.

Analyzer 131 can perform a different type of analysis processing according to the type of time-series sensor value to be analyzed or the type of time-series control value to be analyzed. For example, in the case where the time-series sensor value is a time-series acceleration value, analyzer 131 performs short-time frequency analysis processing or time frequency analysis (wavelet analysis) processing. In the case where the time-series control value is a time-series controlled torque or a controlled rotation speed, analyzer 131 performs short-time frequency analysis processing.

Determiner 132 determines a state of machining performed by machining device 20 using the time-series sensor value or the time-series analysis value. The determining of the state of machining includes determining whether the quality of machining is good or bad. For example, determiner 132 can determine that the quality of machining is bad if it is determined, using the analysis value obtained as a result of analyzer 131 performing time frequency analysis, that a signal intensity of a specific frequency exceeds a predetermined threshold value, and determine that the quality of machining is good if it is determined that the signal intensity does not exceed the threshold value.

Display 14 includes a display screen and displays an image on the display screen. Specifically, display 14 displays the integrated information generated by processing unit 13. Also, when new integrated information is generated by processing unit 13, display 14 updates the displayed integrated information with the new integrated information. Display 14 can also display information that indicates the result of analysis performed by analyzer 131 or information that indicates the determination result from determiner 132. An example of the integrated information displayed by display 14 will be described later.

Hereinafter, processing performed by information processing device 10 will be described in detail.

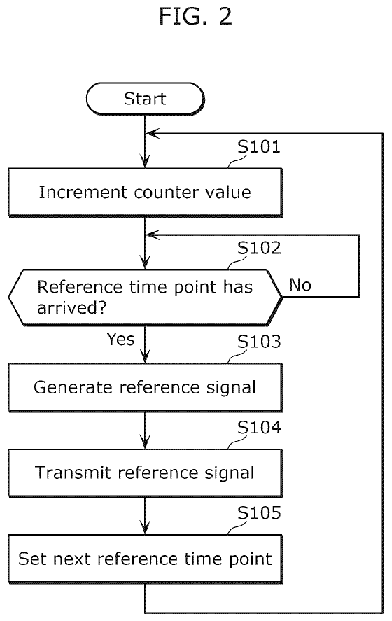

FIG. 2 is a first flowchart illustrating processing performed by information processing device 10 according to the present embodiment. The processing shown in FIG. 2 shows a series of processing operations of generating and transmitting a reference signal performed by generator 12.

It is assumed that generator 12 sets a reference time point when performing the series of processing operations shown in FIG. 2. The reference time point is a time point at which the reference signal is set to be transmitted.

In step S101, generator 12 increments a counter value. For example, the counter value is initialized to 0 before generator 12 first executes step S101 and incremented by one such as 1, 2, and so on each time step S101 is executed.

In step S102, generator 12 determines whether the reference time point has arrived. If it is determined that reference time point has arrived (Yes in step S102), the processing proceeds to step S103. Otherwise (No in step S102), step S102 is performed again. That is, generator 12 stands by in step S102 until reference time point arrives. In step S103, generator 12 generates a reference signal. The reference signal contains a counter value.

In step S104, generator 12 transmits the reference signal generated in step S103 to machining device 20 and sensor device 30 via communication IF 11.

In step S105, generator 12 sets the next reference time point. Generator 12 can set a time point when a predetermined length of time (for example, a several milliseconds to several minutes) has elapsed since the reference time point arrived in step S102 as the next reference time point. After completing step S105, step S101 is performed again.

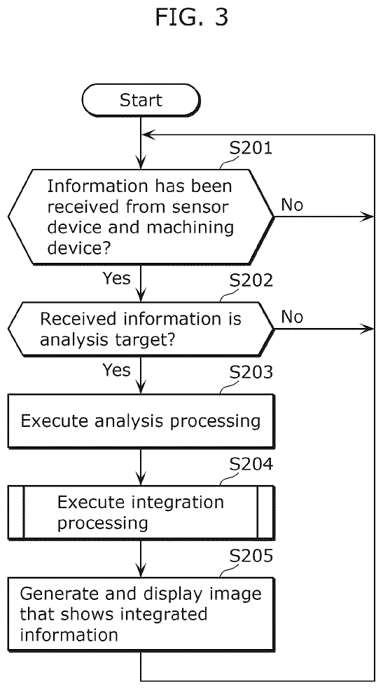

FIG. 3 is a second flowchart illustrating the processing performed by information processing device 10 according to the present embodiment. The series of processing operations shown in FIG. 3 are a series of processing operations of receiving and integrating information performed by processing unit 13.

In step S201, processing unit 13 determines whether information has been received from sensor device 30 and machining device 20. Specifically, the information includes first information and second information, and also includes first reference information and second reference information. If it is determined that the information has been received (Yes in step S201), the processing proceeds to step S202. Otherwise (No in step S201), step S201 is performed again. That is, processing unit 13 stands by in step S201 until the information is received from sensor device 30 and machining device 20.

In step S202, processing unit 13 determines whether the information received in step S201 is an analysis target to be analyzed by analyzer 131. The information that is the analysis target to be analyzed by analyzer 131 may be set in advance, and include, for example, an acceleration value that indicates the vibration of workpiece W, an adjusted position of main spindle 25, or the like.

In step S203, processing unit 13 (specifically, analyzer 131) executes analysis processing on the information received in step S201.

In step S204, processing unit 13 executes integration processing on the information received in step S201 to generate integrated information. Detailed processing operations included in the integration processing will be described later in detail.

In step S205, display 14 generates an image that shows the integrated information generated in step S204, and displays the generated image on a display screen. When the image that shows the integrated information has already been displayed, if new integrated information is generated in step S204, display 14 can update the image by generating an image that shows the new integrated information, and displaying the generated image on the display screen. After completing step S205, step S201 is performed again.

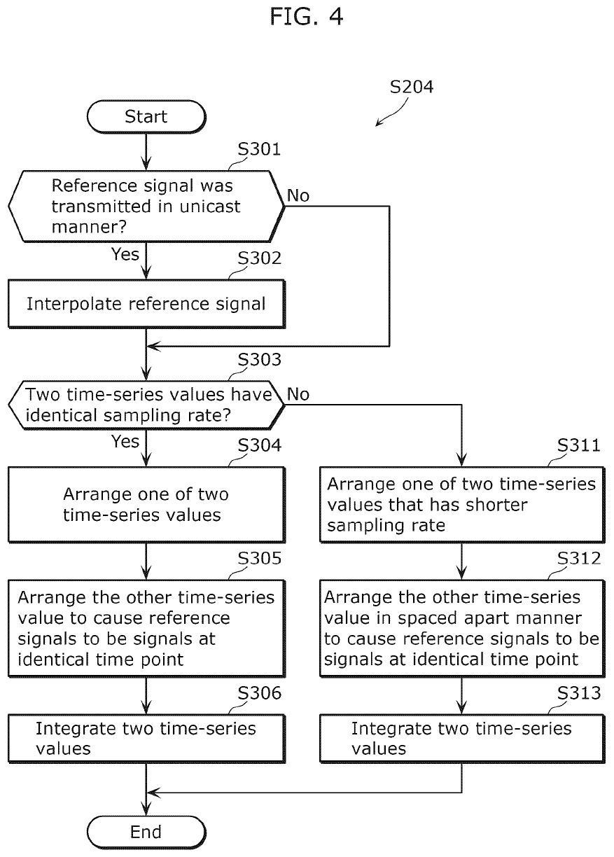

FIG. 4 is a third flowchart illustrating the processing performed by information processing device 10 according to the present embodiment. The processing shown in FIG. 4 shows detailed processing operations included in the integration processing in step S204 shown in FIG. 3.

Here, each of the time-series first value included in the first information that is the integration target and the time-series second value included in the second information that is the integration target may also be referred to as “time-series value”.

In step S301, processing unit 13 determines whether the reference signal was transmitted in a unicast manner from generator 12. If it is determined that the reference signal was transmitted in a unicast manner (Yes in step S301), the processing proceeds to step S302. Otherwise (No in step S301), the processing proceeds to step S303.

In step S302, processing unit 13 interpolates the reference signal. Specifically, when the counter values respectively included in two reference signals that are temporally adjacent to each other are not consecutive (or in other words, when the difference between the counter values is greater than 1), processing unit 13 sets a counter value between the counter values respectively included in the two reference signals at an equal interval between the two reference signals.

In step S303, processing unit 13 determines whether the two time-series values have the identical sampling rate. If it is determined that the two time-series values have the identical sampling rate (Yes in step S303), the processing proceeds to step S304. Otherwise (No in step S303), the processing proceeds to step S311.

In step S304, processing unit 13 arranges one of the two time-series values in a memory space. At this time, processing unit 13 also arranges the reference signal and the counter value that are associated with the time-series value in the memory space together with the time-series value. The same applies hereinafter.

In step S305, processing unit 13 arranges the other one of the two time-series values in the memory space. At this time, processing unit 13 arranges the other time-series value to cause the two time-series values to have a common time axis. More specifically, processing unit 13 arranges the other one of the two time-series values to cause reference signals that respectively correspond to the two time-series values to be signals at the identical time point.

In step S306, processing unit 13 integrates the time-series values arranged in steps S304 and S305.

In step S311, processing unit 13 arranges one of the two time-series values that has a shorter sampling rate in the memory space.

In step S312, processing unit 13 arranges one of the two time-series values that has a longer sampling rate (also referred to “the other time-series value”) in the memory space. At this time, processing unit 13 arranges the other time-series value to cause the two time-series values to have a common time axis. More specifically, processing unit 13 arranges the other time-series value to cause: (i) the reference signals that respectively correspond to the two time-series values to be signals at an identical time point; and (ii) the two time-series values to be spaced apart according to the ratio of the sampling rates of the two time-series values.

For example, when the ratio of the sampling rates of the two time-series values is 2, processing unit 13 arranges the other time-series value at an interval of two times (or in other words, arranges the other time-series value every other). When the ratio of the sampling rates of the two time-series values is 3, processing unit 13 arranges the other time-series value at an interval of three times (or in other words, arranges the other time-series value every two other).

The processing operations in steps S311 and S312 described above are merely an example. It is also possible to perform different processing operations instead of the processing operations in steps S311 and S312 described above as long as the same results as those of the processing operations in steps S311 and S312 described above can be obtained. For example, processing unit 13 may first arrange one of the two time-series values that has a longer sampling rate, and then arrange one of the two time-series values that has a shorter sampling rate. In this case, when arranging one of the two time-series values that has a shorter sampling rate, one of the two time-series values that has a longer sampling rate may be arranged in a spaced apart manner according to the ratio of the sampling rates of the two time-series values (2 times, 3 times, or the like).

In step S313, processing unit 13 integrates the time-series values arranged in steps S311 and S312.

After completing step S306 or step S313, the series of processing operations shown in FIG. 4 end.

Hereinafter, a specific example of the integration processing performed by information processing device 10 will be described. Specifically, the following three cases will be described: a case (1) where the reference signal is transmitted in a broadcast manner, and the time-series value have the identical sampling rate; a case (2) where the reference signal is transmitted in a broadcast manner, and the time-series values have different sampling rates; and a case (3) where the reference signal is transmitted in a unicast manner, and the time-series value have the identical sampling rate.

The case (1) where the reference signal is transmitted in a broadcast manner, and the time-series value have the identical sampling rate will be described.

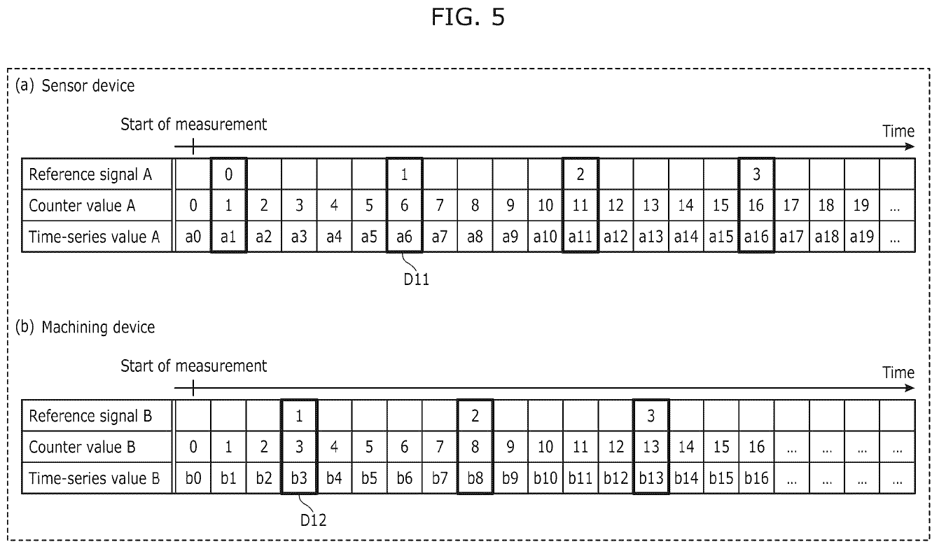

FIG. 5 is a first diagram showing the integration processing performed by information processing device 10 according to the present embodiment.

In (a) in FIG. 5, the information received by information processing device 10 from sensor device 30, specifically, the reference signal (indicated by “reference signal A”), the counter value (indicated by “counter value A”), and the time-series value (“time-series value A”) are shown.

In (a) in FIG. 5, it is assumed that reference signal A, counter value A, and time-series value A arranged in the vertical direction (in other words, arranged at the same position in the right-left direction) are associated with each other as the signal and values at an identical time point. Also, the horizontal axis corresponds to the time axis, which indicates that the further to the right in the diagram, the more time has elapsed.

In the signal and values included in the information, a set of the signal and values at a time point may also be referred to as “value set”.

Reference signal A is a reference signal received from sensor device 30. Reference signal A is associated with counter value A at a time point at which sensor device 30 receives the reference signal from information processing device 10. In the row “reference signal A”, a counter value (for example, 0, 1, 2, and the like) included in reference signal A is written.

Counter value A is a number associated with each time-series value A. Counter value A is incremented by one each time a length of time that corresponds to the sampling rate (for example, 1 millisecond) elapses, and associated with a sensor value generated by sensor device 30 (specifically, converter 32).

Time-series value A is a sensor value generated by sensor device 30 (specifically, converter 32). Time-series value A is generated each time a length of time that corresponds to the sampling rate elapses, or in other words, each time counter value A is incremented.

In (a) in FIG. 5, 0 in the row “counter value A” is associated with a0 in the row “time-series value A”. This means that, when counter value A is 0 (or in other words, at the start of measurement), sensor device 30 generates time-series value A, and generated time-series value A takes a value of a0.

Also, 1 in the row “counter value A” is associated with 0 in the row “reference signal A” and al in the row “time-series value A”. This means that, when counter value A is 1, sensor device 30 receives a reference signal from information processing device 10, and the counter value included in the reference signal is 0. It also means that, when counter value A is 1, sensor device 30 generates time-series value A, and generated time-series value A takes a value of a0.

In (b) in FIG. 5, the reference signal (indicated by “reference signal B”), the counter value (indicated by “counter value B”), and the time-series value (“time-series value B”) received by information processing device 10 from machining device 20 are shown.

Reference signal B is a reference signal transmitted from machining device 20. Reference signal B is associated with counter value B at a time point at which machining device 20 receives the reference signal from information processing device 10. In the row “reference signal B”, a counter value (for example, 0, 1, 2, and the like) included in reference signal B is written.

Counter value B is a number associated with each time-series value B. Counter value B is incremented by one each time a length of time that corresponds to the sampling rate elapses, and associated with a sensor value generated by machining device 20 (specifically, amplifier 22). The sampling rate is the same as the sampling rate of sensor device 30.

Time-series value B is a sensor value generated by sensor device 30 (specifically, converter 32). Time-series value B is generated each time a length of time that corresponds to the sampling rate elapses, or in other words, each time counter value B is incremented.

In (b) in FIG. 5, 0 in the row “counter value B” is associated with b0 in the row “time-series value B”. This means that, when counter value B is 0 (or in other words, at the start of measurement), machining device 20 generates time-series value B, and generated time-series value B takes a value of b0.

Also, 3 in the row “counter value B” is associated with 1 in the row “reference signal B” and b3 in the row “time-series value B”. This means that, when counter value B is 3, a reference signal is received from information processing device 10, and the counter value included in the reference signal is 1. It also means that, when counter value B is 3, sensor device 30 generates time-series value B, and generated time-series value B takes a value of b3.

The timing at which machining device 20 generates time-series value B is independent of the timing at which sensor device 30 generates time-series value A, and thus they are usually different from each other. In other words, reference signal A, counter value A, and time-series value A shown in (a) in FIG. 5 and reference signal B, counter value B, and time-series value B do not have a common time axis.

(a) and (b) in FIG. 5 show an example in which the timing at which machining device 20 generates time-series value B is delayed by 3 milliseconds relative to the timing at which sensor device 30 generates time-series value A. The time difference of 3 milliseconds means a difference between counter value A (or in other words, 6) associated with 1 in the row “reference signal A” of sensor device 30 and counter value B (or in other words, 3) associated with 1 in the “reference signal B” row of machining device 20. This is because sensor device 30 and machining device 20 receive a reference signal transmitted from information processing device 10 in a broadcast manner at substantially the same time point, and then respectively transmit reference signal A and reference signal B in response to the reception of the reference signal.

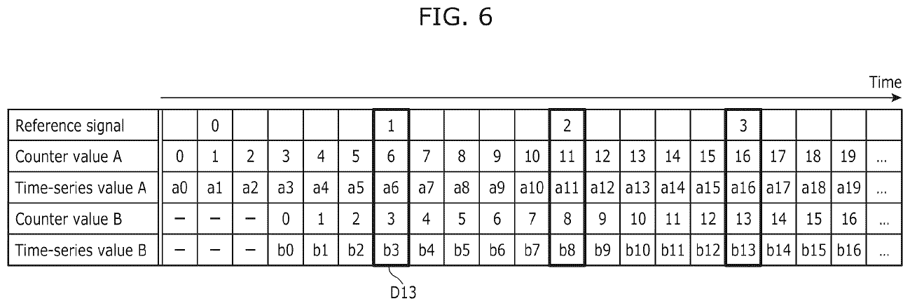

FIG. 6 is a second diagram showing the integration processing performed by information processing device 10 according to the present embodiment. FIG. 6 shows integrated information in which the time-series information shown in (a) in FIG. 5 and the time-series information shown in (b) in FIG. 5 are integrated.

In the integrated information shown in FIG. 6, reference signal, counter value A, time-series value A, counter value B, and time-series value B are shown as information in which they have a common time axis. The integrated information shown in FIG. 6 is information generated by processing unit 13 arranging time-series value A and time-series value B to cause reference signal A and reference signal B based on an identical reference signal to be signals at an identical time point.

Specifically, processing unit 13 generates the integrated information shown in FIG. 6 by arranging time-series value A ((a) in FIG. 5) in the memory space (step S304 shown in FIG. 4), and then arranging time-series value B ((b) in FIG. 5) to cause the reference signal to be aligned in the vertical direction (step S305 shown in FIG. 4).

For example, processing unit 13 generates value set D13 shown in FIG. 6 by integrating value set D11 shown in (a) in FIG. 5 and value set D12 shown in (b) in FIG. 5 to cause value set D11 and value set D12 to be signals at an identical time point.

In the manner as described above, processing unit 13 generates integrated information by integrating time-series value A transmitted from sensor device 30 and time-series value B transmitted from machining device 20.

The case (2) where the reference signal is transmitted in a broadcast manner, and the time-series values have different sampling rates will be described.

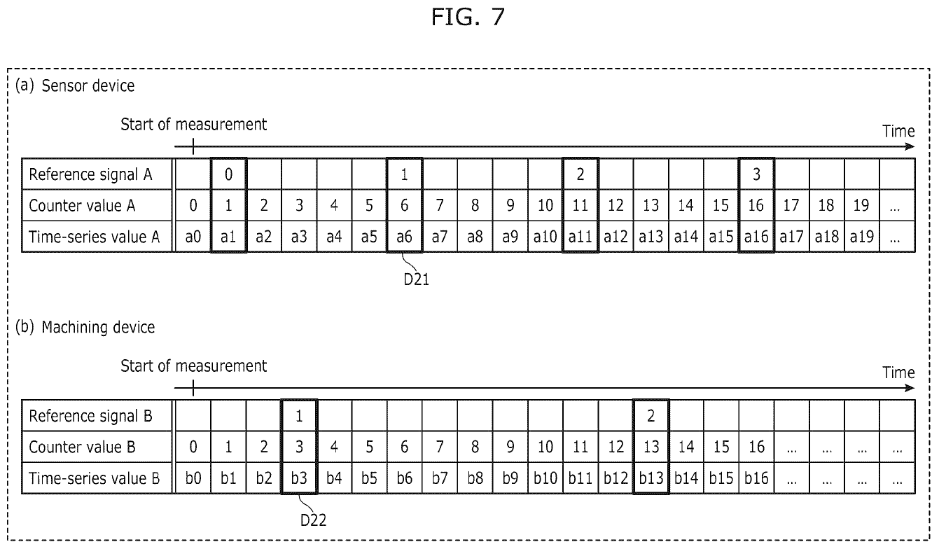

FIG. 7 is a third diagram showing the integration processing performed by information processing device 10 according to the present embodiment.

In (a) in FIG. 7, reference signal A, counter value A, and time-series value A received by information processing device 10 from sensor device 30 are shown. In (a) in FIG. 7, the values of reference signal A, counter value A, and time-series value A are the same as those shown in (a) in FIG. 5.

In (b) in FIG. 7, reference signal B, counter value B, and time-series value B received by information processing device 10 from machining device 20 are shown. Time-series value B shown in (b) in FIG. 7 is a value generated at a sampling rate twice that of time-series value B shown in (b) in FIG. 5. Because time-series value B shown in (b) in FIG. 7 is a value generated at a sampling rate twice that of time-series value B shown in (b) in FIG. 5, the number of time-series value B generated while reference signal B is incremented by one is twice the number of time-series values B shown in (b) in FIG. 7.

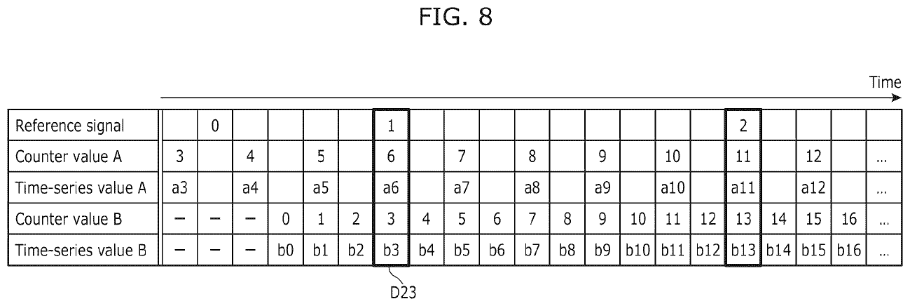

FIG. 8 is a fourth diagram showing the integration processing performed by information processing device 10 according to the present embodiment. FIG. 8 shows integrated information in which the time-series information shown in (a) in FIG. 7 and the time-series information shown in (b) in FIG. 7 are integrated.

In the integrated information shown in FIG. 8, reference signal, counter value A, time-series value A, counter value B, and time-series value B are shown as information in which they have a common time axis. The integrated information shown in FIG. 8 is information generated by processing unit 13 arranging time-series value A in the memory space, and then arranging time-series value B to cause: (i) reference signal A and reference signal B based on an identical reference signal to be signals at an identical time point; and (ii) time-series value A and time-series value B to be spaced apart according to a ratio of the sampling rate of time-series value A and the sampling rate of time-series value B.

Specifically, processing unit 13 generates the integrated information shown in FIG. 8 by arranging time-series value B ((b) in FIG. 7) in the memory space (step S311 shown in FIG. 4), and then arranging time-series value A ((a) in FIG. 5) in a spaced apart manner according to the ratio of the sampling rate of time-series value A and the sampling rate of time-series value B to cause the reference signal to be aligned in the vertical direction (step S312 shown in FIG. 4). Here, the sampling rate ratio is 2, and thus processing unit 13 arranges time-series value A at an interval of two times (or in other words, arranges time-series value A every other time-series value B).

For example, processing unit 13 generates value set D23 shown in FIG. 8 by integrating value set D21 shown in (a) in FIG. 7 and value set D22 shown in (b) in FIG. 7 to cause value set D21 and value set D22 to be signals at an identical time point.

In the manner as described above, processing unit 13 generates integrated information by integrating time-series value A transmitted from sensor device 30 and time-series value B transmitted from machining device 20.

The case (3) where reference signal is transmitted in a unicast manner, and the time-series value have the identical sampling rate will be described.

Here, an example will be described in which generator 12 of information processing device 10 alternately selects sensor device 30 or machining device 20, and transmits the reference signal in a unicast manner.

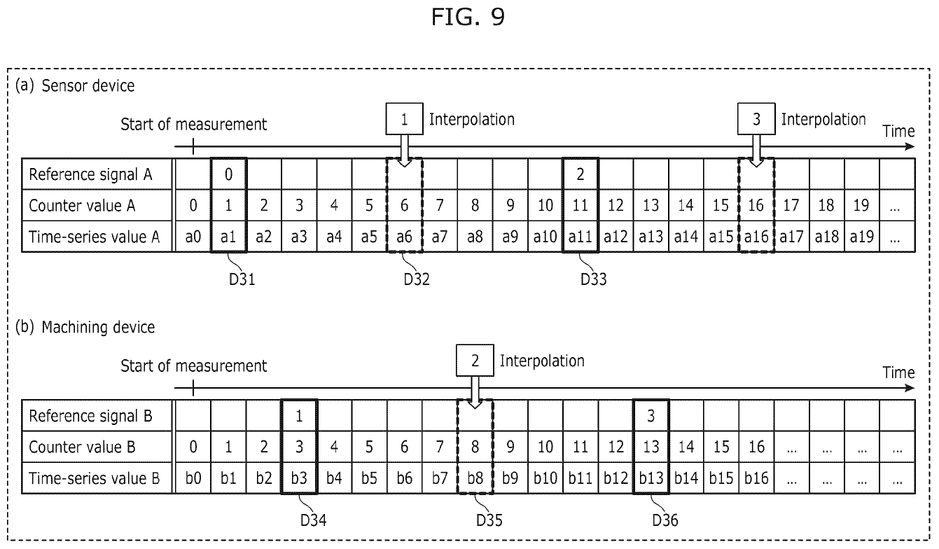

FIG. 9 is a fifth diagram showing the integration processing performed by information processing device 10 according to the present embodiment.

In (a) in FIG. 9, reference signal A, counter value A, and time-series value A received by information processing device 10 from sensor device 30 are shown. In (a) in FIG. 9, the values of counter value A and time-series value A are the same as those shown in (a) in FIG. 5. Reference signal A shown in (a) in FIG. 9 is arranged every other as compared with reference signal A shown in (a) in FIG. 5. This is because information processing device 10 alternately selects sensor device 30 or machining device 20 and transmits the reference signal in a unicast manner. In (a) in FIG. 9, 0, 2, and so on are written as reference signal A.

In (b) in FIG. 9, reference signal B, counter value B, and time-series value B received by information processing device 10 from machining device 20 are shown.

Information processing device 10 alternately selects sensor device 30 or machining device 20 and transmits the reference signal in a unicast manner, and thus reference signal A of machining device 20 is a reference signal arranged every other out of the reference signals transmitted from information processing device 10. In (b) in FIG. 9, 1, 3, and so on are written as reference signal B.

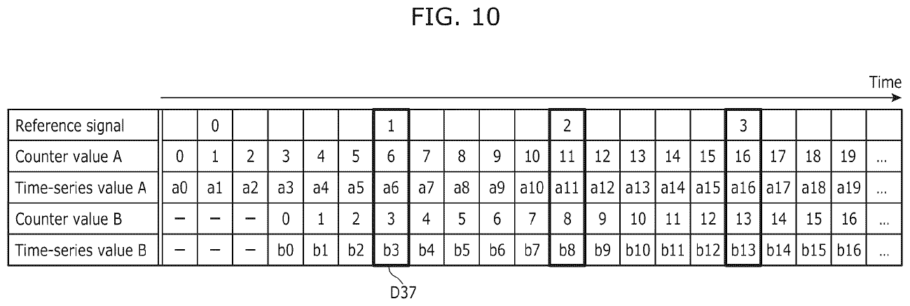

FIG. 10 is a sixth diagram showing the integration processing performed by information processing device 10 according to the present embodiment. FIG. 10 shows integrated information in which the time-series information shown in (a) in FIG. 9 and the time-series information shown in (b) in FIG. 9 are integrated.

In the integrated information shown in FIG. 10, reference signal, counter value A, time-series value A, counter value B, and time-series value B are shown as information in which they have a common time axis. The integrated information shown in FIG. 10 is information generated by processing unit 13 interpolating reference signal A and reference signal B, thereafter arranging time-series value A in the memory space, and arranging time-series value B to cause reference signal A and reference signal B based on an identical reference signal to be signals at an identical time point.

The interpolation of reference signal A is performed when the counter values respectively included in two reference signals that are temporally adjacent to each other are not consecutive (or in other words, when the difference between the counter values is greater than 1). The interpolation of reference signal A is performed by setting a counter value between the counter values respectively included in the two reference signals at an equal interval between the two reference signals.

For example, in (a) in FIG. 9, the counter value of reference signal A included in value set D31 is 0, and the counter value of reference signal A that is included in value set D33 and adjacent to reference signal A included in value set D31 is 2. In this case, processing unit 13 performs interpolation by setting reference signal A whose counter value is 1 in value set D32 that is located midway between value set D31 and value set D33.

Likewise, in (b) in FIG. 9, the counter value of reference signal B included in value set D34 is 1, and the counter value of reference signal B that is included in value set D36 and adjacent to reference signal B included in value set D34 is 3. In this case, processing unit 13 performs interpolation by setting reference signal B whose counter value is 2 in value set D35 that is located midway between value set D34 and value set D36.

After that, processing unit 13 generates the integrated information shown in FIG. 10 by arranging time-series value A ((a) in FIG. 9) in the memory space (step S304 shown in FIG. 4), and then arranging time-series value B ((b) in FIG. 9) to cause the reference signal to be aligned in the vertical direction (step S305 shown in FIG. 4).

For example, processing unit 13 generates value set D37 shown in FIG. 10 by integrating value set D32 shown in (a) in FIG. 9 and value set D34 shown in (b) in FIG. 9 to cause value set D32 and value set D34 to be signals at an identical time point.

In the manner as described above, processing unit 13 generates integrated information by integrating time-series value A transmitted from sensor device 30 and time-series value B transmitted from machining device 20.

In the case where time-series value A and time-series value B have different sampling rates, processing unit 13 generates integrated information in the same manner as shown in FIGS. 7 and 8 after reference signal A and reference signal B have been interpolated.

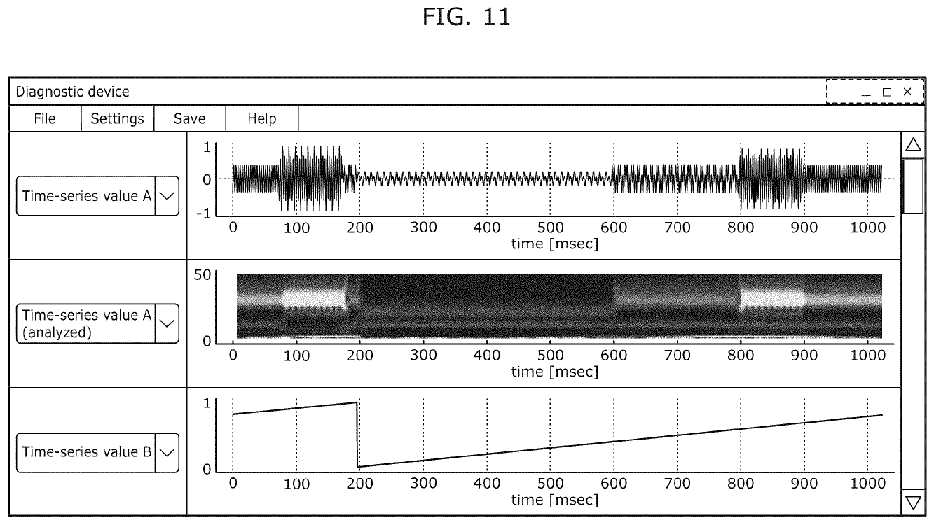

FIG. 11 is a diagram showing an example of how integrated information is displayed by information processing device 10 according to the present embodiment. The example of display of integrated information shown in FIG. 11 is an example in which integrated information obtained by integrating time-series value A and time-series value B to cause time-series value A and time-series value B to have a common time axis is displayed together with the analysis value of time-series value A based on the common time axis.

In FIG. 11, an image of integrated information as information in which time-series value A and time-series value B have a common time axis. More specifically, FIG. 11 shows three graphs including an upper graph, a middle graph, and a lower graph.

The upper graph is a graph that shows time-series value A. In this graph, the horizontal axis represents time, and the vertical axis represents acceleration amplitude in an arbitrary unit.

The middle graph is a graph that shows the analysis result of time-series value A. In this graph, the horizontal axis represents time that is common to that of the upper graph, and the vertical axis represents frequency. The intensity of each frequency component at each time point is expressed by color gradation in the graph.

The lower graph is a graph that shows time-series value B. In this graph, the horizontal axis represents time that is common to that of the upper graph and the middle graph, and the vertical axis represents the position of main spindle 25 in an arbitrary unit.

As the integrated information displayed by display 14, only integrated information of time-series value A and time-series value B, or in other words, integrated information that includes only the upper graph and the lower graph shown in FIG. 11 may be used. Alternatively, as the integrated information displayed by display 14, one or more information items included in the integrated information may be selectively displayed.

In the embodiment and the variations described above, the structural elements may be configured using dedicated hardware, or may be implemented by executing a software program suitable for the structural elements. The structural elements may be implemented by a program executor such as a CPU or a processor reading and executing a software program recorded in a recording medium such as a hard disk drive or a semiconductor memory. Here, the software that implements the method for controlling a machining device according to the embodiment and the variations described above is a program as described below.

Specifically, the program is a program that causes a computer to execute an information processing method to be executed by an information processing device that integrates first information and second information, the first information including a time-series first value that is a time-series sensor value output from a sensor device provided in a machining device or a time-series control value related to control of the machining device, the second information including a time-series second value that is a time-series sensor value output from the sensor device provided in the machining device or a time-series control value related to the control of the machining device, the information processing method including: generating a reference signal and transmitting the reference signal generated to a first device that is a transmission source of the first information and a second device that is a transmission source of the second information; (a) receiving the first information transmitted from the first device that has received the reference signal, and also receiving, as a first reference signal, the reference signal transmitted from the first device together with the first information; (b) receiving the second information transmitted from the second device that has received the reference signal, and also receiving, as a second reference signal, the reference signal transmitted from the second device together with the second information; and (c) integrating the first information and the second information into information in which the first information and the second information have a common time axis, using a time difference between the first reference signal and the second reference signal.

Up to here, the information processing device and the like according to one or more aspects have been described above by way of the embodiment. However, the present invention is not limited to the embodiment given above. Other embodiments obtained by making various modifications that can be conceived by a person having ordinary skill in the art to the above embodiment as well as embodiments constructed by combining structural elements of different embodiments without departing from the scope of the present invention may also be included within the scope of the one or more aspects.

### INDUSTRIAL APPLICABILITY

The present invention is applicable to a diagnostic device or the like that is an information processing device that diagnoses a machining state, a machining phenomenon, machining processing, or the like of a machining device.

### REFERENCE SIGNS LIST

1 system
10 information processing device
11 communication IF
12 generator
13 processing unit
14 display
20 machining device
21 controller
22 amplifier
23 motor
24 encoder
25 main spindle
26 tool
27 stage
30 sensor device
31 sensor
32 converter
131 analyzer
132 determiner
D11, D12, D13, D21, D22, D23, D31, D32, D33, D34, D35, D36, D37 value set
W workpiece

1. An information processing device that integrates first information and second information,
the first information including a time-series first value that is a time-series sensor value output from a sensor device provided in a machining device or a time-series control value related to control of the machining device,
the second information including a time-series second value that is a time-series sensor value output from the sensor device provided in the machining device or a time-series control value related to the control of the machining device,
the information processing device comprising:
a generator that generates a reference signal and transmits the reference signal generated to a first device that is a transmission source of the first information and a second device that is a transmission source of the second information; and
a processing unit that:
(a) receives the first information transmitted from the first device that has received the reference signal, and also receives, as a first reference signal, the reference signal transmitted from the first device together with the first information;
(b) receives the second information transmitted from the second device that has received the reference signal, and also receives, as a second reference signal, the reference signal transmitted from the second device together with the second information; and
(c) integrates the first information and the second information into information in which the first information and the second information have a common time axis, using a time difference between the first reference signal and the second reference signal.

2. The information processing device according to claim 1,
wherein the generator repeatedly broadcasts the reference signal to the first device and the second device, and
the processing unit receives, based on the reference signal repeatedly transmitted from the generator, the first reference signal and the second reference signal repeatedly transmitted from the first device and the second device, and integrates the first information and the second information using the first reference signal and the second reference signal.

3. The information processing device according to claim 2,
wherein the time-series first value and the time-series second value have an identical sampling rate, and
the processing unit integrates the first information and the second information by arranging the time-series first value and the time-series second value to cause the first reference signal and the second reference signal that are based on the reference signal common to the first reference signal and the second reference signal to be signals at an identical time point.

4. The information processing device according to claim 2,
wherein the time-series first value and the time-series second value have different sampling rates, and
the processing unit integrates the first information and the second information by arranging one of the time-series first value or the time-series second value that has a shorter sampling rate and then arranging another one of the time-series first value or the time-series second value to cause: (i) the first reference signal and the second reference signal that are based on the reference signal common to the first reference signal and the second reference signal to be signals at an identical time point; and (ii) the time-series first value and the time-series second value to be spaced apart according to a ratio of the sampling rate of the time-series first value to the sampling rate of the time-series second value.

5. The information processing device according to claim 1,
wherein the generator repeatedly selects one of the first device or the second device and unicasts the reference signal to the one of the first device or the second device selected, and
the processing unit receives, based on the reference signal repeatedly transmitted from the generator, the first reference signal and the second reference signal repeatedly transmitted from the first device and the second device, and integrates the first information and the second information using the first reference signal and the second reference signal.

6. The information processing device according to claim 5,
wherein the time-series first value and the time-series second value have an identical sampling rate, and
the processing unit:
interpolates a first reference signal not received using a plurality of first reference signals received, each of which is the first reference signal;
interpolates a second reference signal not received using a plurality of second reference signals received, the second reference signal not received and the plurality of second reference signals received being the second reference signal as defined in claim 1; and
integrates the first information and the second information by arranging the time-series first value and the time-series second value to cause the first reference signal and the second reference signal that are based on the reference signal common to the first reference signal and the second reference signal to be signals at an identical time point.

7. The information processing device according to claim 5,
wherein the time-series first value and the time-series second value have an identical sampling rate, and
the processing unit:
interpolates a first reference signal not received using a plurality of first reference signals received, each of which is the first reference signal;
interpolates a second reference signal not received using a plurality of second reference signals received, the second reference signal not received and the plurality of second reference signals received being the second reference signal as defined in claim 1; and
integrates the first information and the second information by (1) arranging one of the time-series first value or the time-series second value that has a shorter sampling rate, and then (2) arranging another one of the time-series first value or the time-series second value to cause: (i) the first reference signal and the second reference signal that are based on the reference signal common to the first reference signal and the second reference signal to be signals at an identical time point; and (ii) the time-series first value and the time-series second value to be spaced apart according to a ratio of the sampling rate of the time-series first value to the sampling rate of the time-series second value.

8. The information processing device according to claim 1,
wherein the time-series first value or the time-series second value is a time-series sensor value or a time-series control value, and
the processing unit includes an analyzer that analyzes the time-series sensor value or the time-series control value.

9. The information processing device according to claim 8,
wherein the analyzer performs a different type of analysis processing according to a type of the time-series sensor value to be analyzed or a type of the time-series control value to be analyzed.

10. The information processing device according to claim 8,
wherein the processing unit includes a determiner that determines a state of machining performed by the machining device using a result of the analysis performed by the analyzer.

11. The information processing device according to claim 1,
wherein the processing unit generates integrated information by integrating the first information and the second information, and
the information processing device further includes a display that displays the integrated information.

12. The information processing device according to claim 11,
wherein the generator generates a new reference signal and transmits the new reference signal generated,
the processing unit generates new integrated information by receiving new first information, new first reference signal, new second information, and new second reference signal, and integrating the new first information and the new second information, and
the display updates the integrated information displayed with the new integrated information.

13. The information processing device according to claim 11 or 12,
wherein the display receives a selection of one or more information items included in the integrated information by a user, and displays at least one of the one or more information items according to the selection received.

14. The information processing device according to claim 1,
wherein the sensor device includes at least one of an acceleration sensor, a voltage sensor, an electric current sensor, or a temperature sensor.

15. An information processing method to be executed by an information processing device that integrates first information and second information,
the first information including a time-series first value that is a time-series sensor value output from a sensor device provided in a machining device or a time-series control value related to control of the machining device,
the second information including a time-series second value that is a time-series sensor value output from the sensor device provided in the machining device or a time-series control value related to the control of the machining device,
the information processing method comprising:
generating a reference signal and transmitting the reference signal generated to a first device that is a transmission source of the first information and a second device that is a transmission source of the second information;
(a) receiving the first information transmitted from the first device that has received the reference signal, and also receiving, as a first reference signal, the reference signal transmitted from the first device together with the first information;
(b) receiving the second information transmitted from the second device that has received the reference signal, and also receiving, as a second reference signal, the reference signal transmitted from the second device together with the second information; and
(c) integrating the first information and the second information into information in which the first information and the second information have a common time axis, using a time difference between the first reference signal and the second reference signal.

16. The information processing method according to claim 15,
wherein the integrating includes generating integrated information of the first information and the second information, and
the information processing method further includes displaying the integrated information on a display.

17. A non-transitory computer-readable recording medium having recorded thereon a computer program for causing a computer to execute the information processing method according to claim 15.
